(19) United States
(12) Patent Application Publication
(10) Pub. No.: US 2022/0234145 A1
(43) Pub. Date: Jul. 28, 2022

(54) METHOD FOR DETERMINING LASER IRRADIATION STATE

(71) Applicant: HONDA MOTOR CO., LTD., Minato-ku, Tokyo (JP)

(72) Inventors: Taisei Wakisaka, Haga-gun, Tochigi-ken (JP); Takeshi Akiyama, Haga-gun, Tochigi-ken (JP)

(21) Appl. No.: 17/617,628

(22) PCT Filed: Jun. 9, 2020
(86) PCT No.: PCT/JP2020/022663

§ 371 Date: Dec. 9, 2021

(30) Foreign Application Priority Data
Jun. 13, 2019 (JP) 2019-110024

(51) Int. Cl. B23K 26/70; B23K 1/005

(52) U.S. Cl. CPC B23K 26/707; B23K 1/0056

(57) ABSTRACT

Provided is a method for determining a laser irradiation state whereby the output of a laser can be acquired with high accuracy. This method for determining a laser irradiation state determines the irradiation state of a laser irradiated by a laser irradiation device and includes: an output stabilization time acquisition step for acquiring, as an output stabilization time, the time from the start of laser irradiation by the laser irradiation device until the stabilization of the output of the laser; an energy acquisition step for acquiring, after the output stabilization time or longer has elapsed from the start of the laser irradiation by the laser irradiation device, the energy of the laser irradiated by the laser irradiation device in a pre-set prescribed period; a conversion step for converting the acquired energy to the output of the laser irradiated by the laser irradiation device; and a state determination step for determining the irradiation state of the laser on the basis of the converted output of the laser.

### TECHNICAL FIELD

The present invention relates to a laser irradiation state determination method (method for determining laser irradiation state) for determining a state of a laser irradiation device in accordance with an output of a laser emitted by the laser irradiation device.

### BACKGROUND ART

JP 6279589 B2 and JP 6021929 B2 disclose techniques for measuring laser output of a laser irradiation device.

### SUMMARY OF THE INVENTION

The techniques disclosed in JP 6279589 B2 and JP 6021929 B2 do not take into account the fact that the output characteristics at the rising edge immediately after the start of laser irradiation differ from one laser irradiation device to another. Therefore, there is a problem in that the accuracy of the obtained laser output is low.

The present invention has been made to solve the above-described problem, and an object thereof is to provide a laser irradiation state determination method capable of acquiring an output of a laser with high accuracy.

According to an aspect of the present invention, there is provided a laser irradiation state determination method for determining an irradiation state of a laser beam emitted by a laser irradiation device, the method including: an output stabilization time acquisition step of acquiring, as an output stabilization time, a time from when the laser irradiation device starts irradiation of the laser beam to when an output of the laser beam is stabilized; an energy acquisition step of acquiring energy of the laser beam irradiated by the laser irradiation device for a predetermined time period set in advance, after the output stabilization time or more has elapsed since the laser irradiation device started the irradiation of the laser beam; a conversion step of converting the acquired energy into the output of the laser beam irradiated by the laser irradiation device; and a state determination step of determining the irradiation state of the laser beam based on the converted output of the laser beam.

According to the present invention, it is possible to obtain output of a laser beam with high accuracy.

### BRIEF DESCRIPTION OF DRAWINGS

FIG. 1 is a schematic view showing how a vehicle body of an automobile is processed by a laser brazing machine;

FIG. 2 is a block diagram showing a configuration of a laser irradiation state determination device;

FIG. 3 is a graph showing a change in laser output with respect to time of the laser irradiation device;

FIG. 4 is a flowchart showing an energy acquisition process performed by an energy acquisition unit;

FIG. 5 is a graph showing a change in laser output with respect to time of the laser irradiation device;

FIG. 6 is a flowchart showing an output conversion process;

FIG. 7 is a flowchart showing a laser irradiation state determination process;

FIGS. 8A, 8B, and 8C are diagrams illustrating conventional methods for obtaining the laser output;

FIGS. 9A, 9B, and 9C are diagrams for explaining a method for obtaining the laser output, according to a first embodiment;

FIG. 10 is a block diagram showing a configuration of the laser irradiation state determination device;

FIG. 11 is a flowchart showing a laser irradiation state determination process;

FIG. 12 is an example of time-series data stored in a time-series data storage unit;

FIG. 13 is an example of time-series data stored in the time-series data storage unit;

FIG. 14 is an example of time-series data stored in the time-series data storage unit;

FIG. 15 is an example of time-series data stored in the time-series data storage unit; and

FIG. 16 is an example of time-series data stored in the time-series data storage unit.

### DESCRIPTION OF THE INVENTION

### First Embodiment

### [Configuration of Laser Brazing Machine]

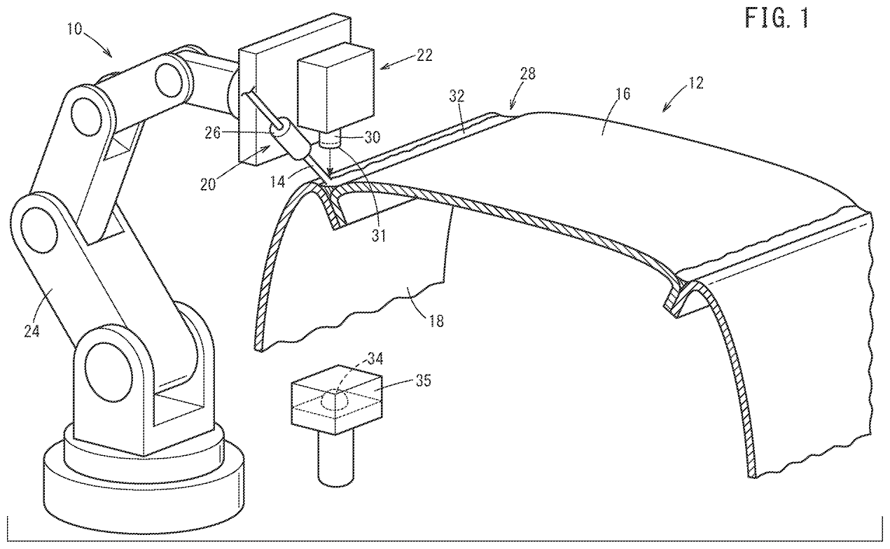

FIG. 1 is a schematic view showing how a vehicle body 12 of an automobile is processed by a laser brazing machine 10. A laser brazing machine 10 joins steel plates to each other by using a brazing material 14 having a melting point lower than that of the steel plates constituting the vehicle body 12. A laser brazing machine 10 sequentially performs machining on vehicle bodies 12 flowing on a line. FIG. 1 shows how a laser brazing machine 10 joins a roof panel 16 and a side panel 18 of a vehicle body 12.

The laser brazing machine 10 includes a brazing material supply device 20, a laser irradiation device 22, and a transfer robot 24.

The brazing material supply device 20 reels out a wire-shaped brazing material 14 from a reel (not shown), and supplies the brazing material 14 from a guide 26 to a portion to be joined 28 between the roof panel 16 and the side panel 18.

The laser irradiation device 22 irradiates the brazing material 14 supplied to the portion to be joined 28 with a laser beam from an irradiation head 30. The irradiation head 30 is connected to a laser oscillator (not shown) via a transmission cable. The brazing material 14 is melted by the energy of the laser, and then the brazing material 14 is cooled and solidified to form a bead 32. The roof panel 16 and the side panel 18 are joined by the bead 32. A protective glass 31 is provided at a portion, of the irradiation head 30 of the laser irradiation device 22, from which a laser beam is emitted.

The transfer robot 24 is a robot that transfers the brazing material supply device 20 and the laser irradiation device 22. The transfer robot 24 moves the brazing material supply device 20 and the laser irradiation device 22 along the portion to be joined 28 of the vehicle body 12. Further, the transfer robot 24 moves the laser irradiation device 22 above a laser output sensor 34. The laser irradiation device 22 emits a laser beam toward the laser output sensor 34. The laser output sensor 34 detects the output of the laser beam. Based on the detected laser output, a laser irradiation state determination unit 44 described later determines the laser irradiation state of the laser irradiation device 22. The measurement of the laser output of the laser irradiation device 22 is performed each time the machining of one vehicle body 12 is completed. The measurement of the laser output of the laser irradiation device 22 may be performed every time before the machining of one vehicle body 12 is started. The laser output sensor 34 is covered with a protective glass 35.

### [Configuration of Laser Irradiation State Determination Device]

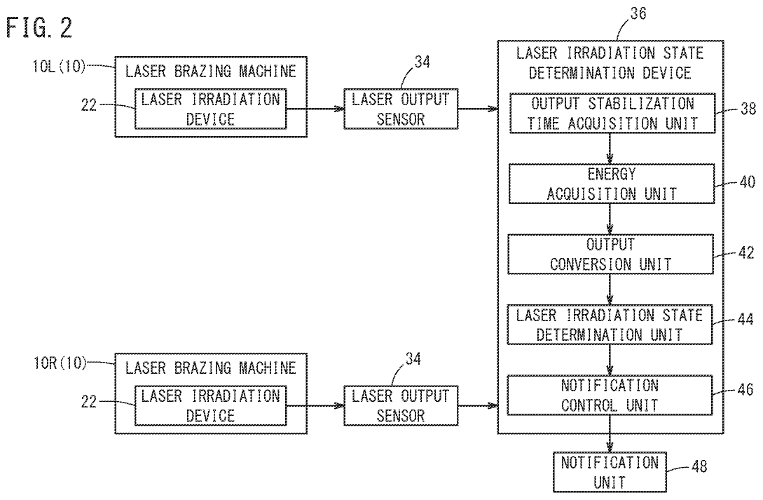

FIG. 2 is a block diagram showing a configuration of a laser irradiation state determination device 36. A laser brazing machine 10L and a laser brazing machine 10R are installed across a line which the vehicle bodies 12 move down. The laser irradiation state determination device 36 according to the present embodiment determines the laser irradiation state of the laser irradiation device 22 included in each of the laser brazing machines 10L and 10R. The laser irradiation state determination device 36 includes an output stabilization time acquisition unit 38, an energy acquisition unit 40, an output conversion unit 42, a laser irradiation state determination unit 44, and a notification control unit 46. The laser irradiation state determination device 36 may determine the laser irradiation state for the laser irradiation device 22 included in one laser brazing machine 10 or for the laser irradiation device 22 included in each of three or more laser brazing machines 10.

The output stabilization time acquisition unit 38 acquires an output stabilization time from laser output information detected by the laser output sensor 34. The output stabilization time is a time from the start of laser irradiation by the laser irradiation device 22 to the stabilization of the laser output. The output stabilization time will be described later in detail.

The energy acquisition unit 40 acquires the energy of the laser beam emitted by the laser irradiation device 22 for a predetermined time period from the laser output information detected by the laser output sensor 34. The process of acquiring laser energy will be described later in detail.

The output conversion unit 42 converts the laser energy acquired by the energy acquisition unit 40, into the laser output. An output conversion process for converting the laser energy into the laser output will be described later in detail.

The laser irradiation state determination unit 44 determines the laser irradiation state of the laser irradiation device 22 based on the laser output obtained by the output conversion unit 42. The determination process of the laser irradiation state of the laser irradiation device 22 will be described later in detail.

The notification control unit 46 controls a notification unit 48 based on the laser irradiation state of the laser irradiation device 22 determined by the laser irradiation state determination unit 44, and performs notification to the operator. The notification unit 48 may be a display device that displays characters, images, or the like, or may be an acoustic device that emits sound or the like.

The output stabilization time acquisition unit 38, the energy acquisition unit 40, the output conversion unit 42, the laser irradiation state determination unit 44, and the notification control unit 46 are realized by a processor executing a program stored in a storage medium (not illustrated).

### [Output Stabilization Time Acquisition Process]

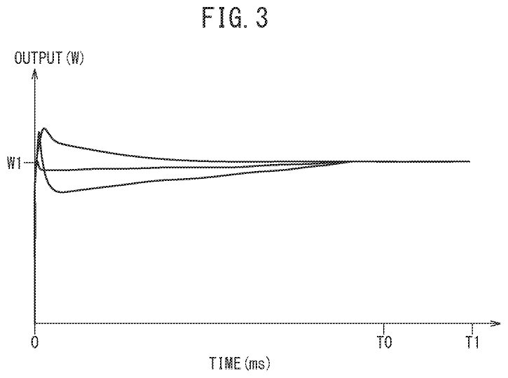

FIG. 3 is a graph showing change in laser output with respect to time of the laser irradiation device 22. The graph of FIG. 3 shows an example of change in laser output with respect to time, from the start of laser irradiation to the elapse of a set time T1 [ms], in each of the three laser irradiation devices 22. Each of the three laser irradiation devices 22 is controlled so as to irradiate a laser beam having a set output W1 [W].

As shown in FIG. 3, immediately after the laser irradiation is started, the characteristics of the laser output are greatly different for each individual laser irradiation device 22. In addition, immediately after the start of laser irradiation, the amount of change in laser output with respect to time in each laser irradiation device 22 is large. As time elapses from the start of laser irradiation, the difference in laser output characteristics among the individual laser irradiation devices 22 decreases. In addition, as time elapses from the start of laser irradiation, the amount of change in laser output with respect to time in each laser irradiation device 22 decreases.

When the change in laser output of the laser irradiation device 22 with respect to time changes as shown in the graph of FIG. 3, the output stabilization time is T0 [ms]. The output stabilization time acquisition unit 38 acquires this output stabilization time. The output stabilization time is measured in advance using a device equivalent to the laser irradiation device 22 which is a determination target of the laser irradiation state. Alternatively, before the determination of the laser irradiation state is performed, the output stabilization time may be measured using the laser irradiation device 22 that is the determination target of the laser irradiation state.

### [Energy Acquisition Process]

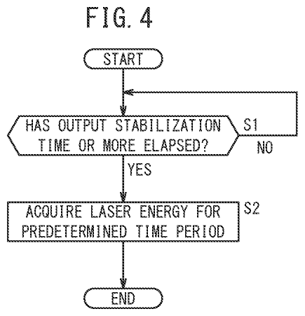

FIG. 4 is a flowchart illustrating an energy acquisition process performed by the energy acquisition unit 40. The energy acquisition process is executed each time the laser irradiation state of the laser irradiation device 22 is determined. For performing the determination of the laser irradiation state of the laser irradiation device 22, the laser brazing machine 10 is controlled so as to irradiate the laser beam of the set output W1 [W] from the laser irradiation device 22 toward the laser output sensor 34 for the set time T1 [ms].

In step S1, the energy acquisition unit 40 determines whether or not the output stabilization time or more has elapsed since the laser irradiation device 22 started the laser irradiation. If the output stabilization time or more has elapsed, the process proceeds to step S2. If the output stabilization time has not elapsed, the determination of step S1 is repeated.

In step S2, the energy acquisition unit 40 acquires, as energy, a value obtained by integrating the laser output detected, by the laser output sensor 34, for a predetermined time period ΔT2 [ms] which is set in advance, and ends the energy acquisition process.

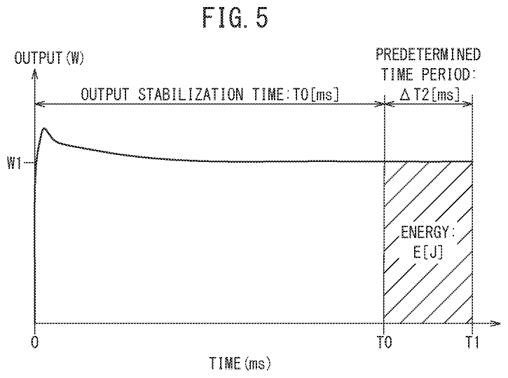

FIG. 5 is a graph showing an example of change in laser output with respect to time of the laser irradiation device 22 detected by the laser output sensor 34. The graph of FIG. 5 shows an example of change in laser output with respect to time from when the laser irradiation device 22 starts irradiation of the laser to when a set time T1 [ms] elapses.

After the output stabilization time T0 [ms] or more has elapsed from the start of laser irradiation by the laser irradiation device 22, the energy acquisition unit 40 acquires, as energy, the value obtained by integrating the laser output for a predetermined time period ΔT2 [ms]. When the laser output varies as shown in FIG. 5, the energy acquisition unit 40 acquires E [J] as the laser energy irradiated from the laser irradiation device 22 for a predetermined time period ΔT2 [ms].

### [Output Conversion Process]

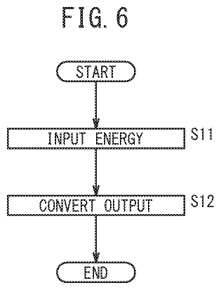

FIG. 6 is a flowchart showing an output conversion process performed by the output conversion unit 42. The output conversion process is executed each time the energy acquisition process described above ends.

In step S11, the output conversion unit 42 inputs the laser energy acquired by the energy acquisition unit 40, and then the process proceeds to step S12.

In step S12, the output conversion unit 42 converts the laser energy into the laser output, and ends the output conversion process. When the laser output changes as shown in FIG. 5, the energy acquisition unit 40 acquires E [J] as the energy for a predetermined time period ΔT2 [ms]. The output conversion unit 42 converts the laser energy into the laser output by dividing the acquired laser energy E [J] by the predetermined time period ΔT2.

### [Laser Irradiation State Determination Process]

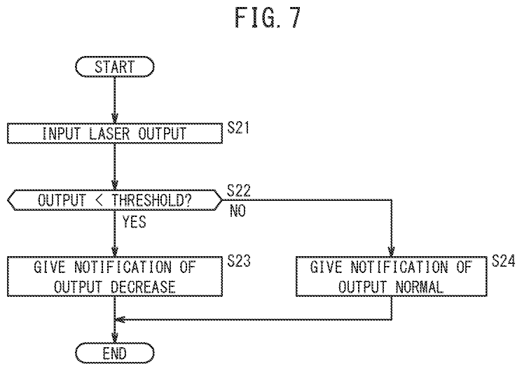

FIG. 7 is a flowchart illustrating a laser irradiation state determination process performed by the laser irradiation state determination unit 44 and the notification control unit 46.

In step S21, the laser irradiation state determination unit 44 inputs the laser output obtained by the output conversion unit 42, and the process proceeds to step S22.

In step S22, the laser irradiation state determination unit 44 determines whether the laser output input in step S21 is less than a preset threshold value or not. When the laser output is less than the threshold value, the process proceeds to step S23. When the laser output is equal to or greater than the threshold value, the process proceeds to step S24.

In step S23, the notification control unit 46 controls the notification unit 48 to notify the operator that the output of the laser irradiation device 22 has decreased, and the laser irradiation state determination process is terminated.

In step S24, the notification control unit 46 controls the notification unit 48 to notify the operator that the output of the laser irradiation device 22 is normal, and the laser irradiation state determination process is terminated.

### [Operational Effects]

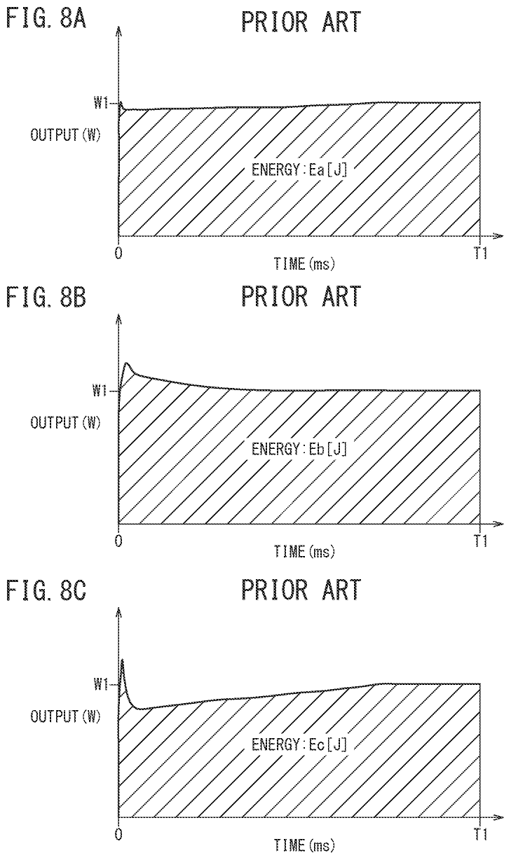

FIGS. 8A, 8B, and 8C are diagrams illustrating conventional methods for obtaining the laser output; The graphs of FIGS. 8A to 8C show change in laser output with respect to time from when the laser irradiation starts until the set time T1 [ms] elapses in each of the three laser irradiation devices 22.

In the conventional laser output acquisition method, the laser output is acquired based on energy obtained by integrating the laser output from immediately after the laser irradiation device 22 starts laser irradiation. The laser output sensor 34 of the present embodiment has high responsiveness, and can detect a change in laser output during laser irradiation of several milliseconds. Therefore, the energy of the laser irradiated for a short period of time can be obtained, and the laser output can be obtained in a short period of time. However, a period during which the laser output is not stable makes up a relatively large proportion of the entire period during which the laser energy is obtained, and there is a problem in that the accuracy of the laser output converted from the obtained laser energy reduces.

In a case where the laser output varies as illustrated in FIGS. 8A to 8C, the energy of the laser beam irradiated during a time period from 0 [ms] to the set time T1 [ms] after each of the laser irradiation devices 22 starts the irradiation of the laser is Ea [J], Eb [J], and Ec [J] (Eb>Ea>Ec). The laser output converted by dividing each of the energies Ea [J], Eb [J], and Ec [J] by the set time T1 [ms] has a large variation among the individual laser irradiation devices 22. Therefore, in a case where the laser irradiation state of the laser irradiation device 22 is determined based on the laser output acquired by the conventional acquisition method, there is a possibility that an erroneous determination is made.

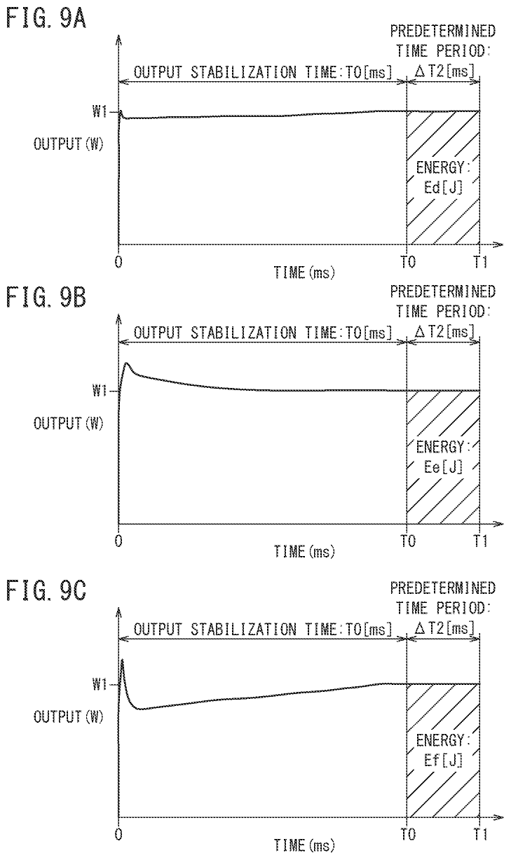

FIGS. 9A, 9B, and 9C are diagrams illustrating a method of obtaining the laser output according to the present embodiment. The graphs of FIGS. 9A to 9C show change in laser output with respect to time from when a laser irradiation starts until the set time T1 [ms] elapses, in each of the three laser irradiation devices 22.

In the case where the laser output changes as shown in FIGS. 9A to 9C, after the output stabilization time T0 [ms] elapses from the start of laser irradiation by each of the laser irradiation devices 22, energy Ed [J], energy Ee [J], and energy Ef [J] of the laser irradiated for a predetermined time period ΔT2 [ms] from the output stabilization time T0 [ms] to the set time T1 [ms] become substantially equal. The laser outputs obtained by dividing the energies Ed [J], Ee [J], and Ef [J] by the predetermined time period ΔT2 [ms] are substantially equal to each other.

In general, when the laser output is obtained based on the energy of the laser irradiated for a time period as long as possible, the obtained laser output has higher accuracy. However, in the present embodiment, in consideration of the characteristics of the laser output sensor 34, the output is acquired based on the energy of the laser beam irradiated for a short time period excluding a time period during which the laser output is not stable. Accordingly, the laser output can be obtained with high accuracy, and the accuracy of the determination of the laser irradiation state of the laser irradiation device 22 based on the laser output can be improved.

### Second Embodiment

The laser irradiation state determination device 36 according to the present embodiment specifically determines the cause of the decrease in output of the laser irradiated by the laser irradiation device 22 from time-series data of the laser output of the laser irradiation device 22 obtained by the output conversion unit 42.

### [Configuration of Laser Irradiation State Determination Device]

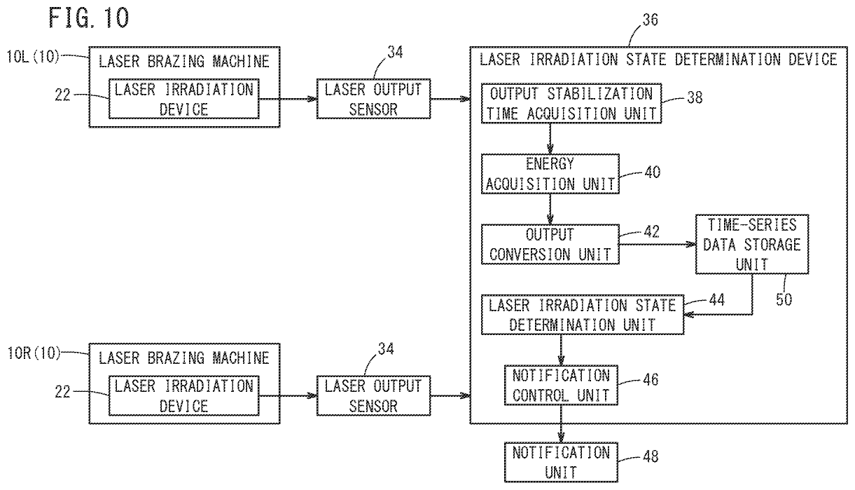

FIG. 10 is a block diagram showing a configuration of the laser irradiation state determination device 36. A laser brazing machine 10L and a laser brazing machine 10R are installed across a line which the vehicle bodies 12 move down. The laser irradiation state determination device 36 according to the present embodiment determines the laser irradiation state of the laser irradiation device 22 included in each of the laser brazing machines 10L and 10R.

The laser irradiation state determination device 36 includes an output stabilization time acquisition unit 38, an energy acquisition unit 40, an output conversion unit 42, a time-series data storage unit 50, a laser irradiation state determination unit 44, and a notification control unit 46. Among these components, the output stabilization time acquisition unit 38, the energy acquisition unit 40, and the output conversion unit 42 are the same as the output stabilization time acquisition unit 38, the energy acquisition unit 40, and the output conversion unit 42 of the first embodiment. The laser irradiation state determination unit 44 and the notification control unit 46 are partially different from the laser irradiation state determination unit 44 and the notification control unit 46 of the first embodiment in the contents of processing to be performed. The time-series data storage unit 50 is a constituent element added in the present embodiment.

Each time the laser irradiation state of the laser irradiation device 22 is determined, the time-series data storage unit 50 stores, as time-series data, the laser output obtained by the output conversion unit 42 in association with the time at which the laser irradiation state of the laser irradiation device 22 is determined.

The laser irradiation state determination unit 44 determines the laser irradiation state of the laser irradiation device 22 based on the time-series data stored in the time-series data storage unit 50. The laser irradiation state determination process of the laser irradiation device 22 will be described later in detail.

The notification control unit 46 controls the notification unit 48 based on the laser irradiation state of the laser irradiation device 22 determined by the laser irradiation state determination unit 44, and performs notification to the operator.

The output stabilization time acquisition unit 38, the energy acquisition unit 40, the output conversion unit 42, the laser irradiation state determination unit 44, and the notification control unit 46 are realized by a processor executing a program stored in a storage medium (not illustrated). The time-series data storage unit 50 is realized by a storage medium (not shown).

### [Laser Irradiation State Determination Process]

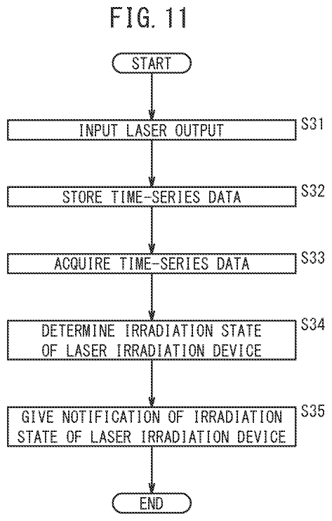

FIG. 11 is a flowchart illustrating a laser irradiation state determination process performed by the laser irradiation state determination unit 44 and the notification control unit 46.

In step S31, the laser irradiation state determination unit 44 inputs the laser output obtained by the output conversion unit 42, and the process proceeds to step S32.

In step S32, the laser irradiation state determination unit 44 stores the laser output input in step S31 in the time-series data storage unit 50 as time-series data in association with the sequential order in which the laser output is input, and then the process proceeds to step S33.

In step S33, the laser irradiation state determination unit 44 acquires the time-series data of laser output from the time-series data storage unit 50, and the process proceeds to step S34.

In step S34, the laser irradiation state determination unit 44 determines the laser irradiation state of the laser irradiation device 22 based on the time-series date, and the process proceeds to step S35. The determination process of the laser irradiation state of the laser irradiation device 22 based on the time-series data will be described later in detail.

In step S35, the notification control unit 46 controls the notification unit 48 to notify the operator of the laser irradiation state of the laser irradiation device 22 determined in step S34, and the laser irradiation state determination process ends.

### [Details of Determination of Laser Irradiation State]

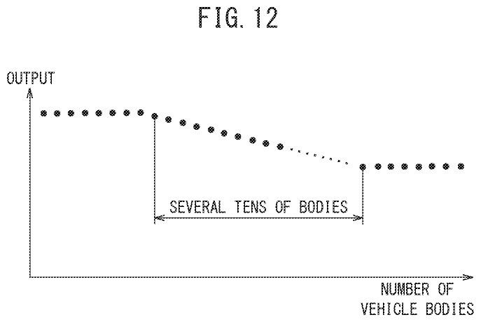

FIGS. 12, 13, and 14 are examples of time-series data stored in the time-series data storage unit 50. As described above, the measurement of the laser output of the laser irradiation device 22 is performed each time the machining of one vehicle body 12 is completed. Accordingly, the time-series data shown in FIGS. 12 to 14 is represented as a graph showing a change in laser output with respect to the number of vehicle bodies 12 machined by the laser irradiation device 22.

An air knife is provided on the surface of the protective glass 31 of the irradiation head 30 of the laser irradiation device 22. The air knife prevents spatters and fumes from entering the protective glass 31 side. However, in some cases, spatters or fumes may pass through the air knife to enter the protective glass 31 side and adhere to the protective glass 31. When the spatter or fume adheres to the protective glass 31, the laser output irradiated by the laser irradiation device 22 decreases. The change of the time-series data differs depending on whether what is attached to the protective glass 31 is the spatter or the fume, and further depending on the main component of the spatter.

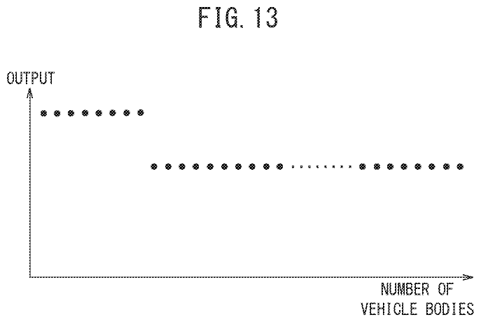

The time-series data in FIG. 12 shows an example of a case where a spatter containing zinc as a main component adheres to the protective glass 31 of the irradiation head 30 of the laser irradiation device 22. The time-series data in FIG. 13 shows an example of a case where a spatter containing copper as a main component adheres to the protective glass 31 of the irradiation head 30 of the laser irradiation device 22.

By irradiating the brazing material 14 with the laser, fine particles (spatters) of zinc or copper contained in the brazing material 14 are scattered. Spatters containing zinc as the main component have a relatively low melting point. The spatters containing zinc as the main component adheres to the protective glass 31 and thereafter is burned and spread by heat of the laser. Therefore, the laser output gradually decreases over several tens of vehicle bodies after the spatters containing zinc as the main component have been attached to the protective glass 31. The laser irradiation state determination unit 44 determines that spatters containing zinc as the main component are attached to the protective glass 31 in a case where the laser output gradually decreases over several tens of vehicle bodies, as shown in the time-series data illustrated in FIG. 12. In this case, the notification control unit 46 controls the notification unit 48 to notify the operator that there is a possibility that the protective glass 31 has, adhered thereto, spatters containing zinc as the main component.

The size of the spatter containing copper as the main component is larger than the size of the spatter containing zinc as the main component. Therefore, when spatters containing copper as the main component adhere to the protective glass 31, the output of the laser is greatly reduced. When the output of the laser decreases stepwise as shown in the time-series data in FIG. 13, the laser irradiation state determination unit 44 determines that the protective glass 31 has, attached thereto, spatters containing copper as the main component. In this case, the notification control unit 46 controls the notification unit 48 to notify the operator that there is a possibility that the protective glass 31 has, attached thereto, spatters containing copper as the main component.

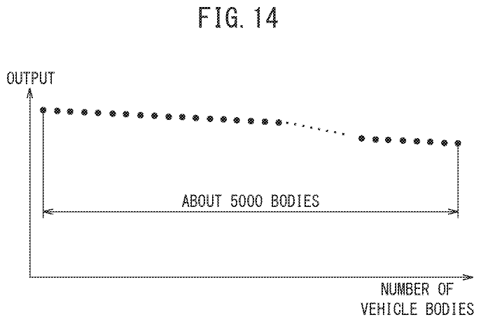

The time-series data of FIG. 14 shows an example of a case in which fumes adhere to the protective glass 31 of the irradiation head 30 of the laser irradiation device 22. The amount of fumes adhering to the protective glass 31 increases in accordance with the number of vehicle bodies 12 machined by the laser irradiation device 22. When the laser irradiation device 22 machines about 5000 vehicle bodies 12, the output of the laser irradiated by the laser irradiation device 22 is reduced by about 1% to 2%. Although depending on the number of vehicle bodies machined per day, the protective glass 31 needs to be replaced in about one week. The laser irradiation state determination unit 44 determines that the amount of fumes adhering to the protective glass 31 is increasing when the output of the laser decreases by approximately 1% to 2% over approximately 5000 vehicle bodies as shown in the time-series data illustrated in FIG. 14. In this case, the notification control unit 46 controls the notification unit 48 to notify the operator that the fumes adhering to the protective glass 31 are increasing.

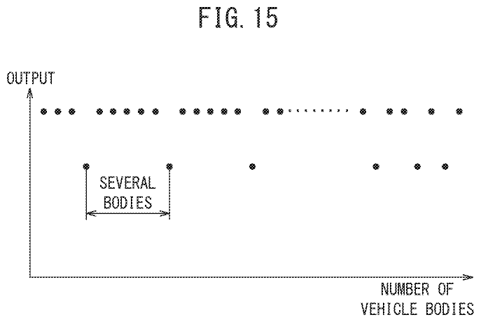

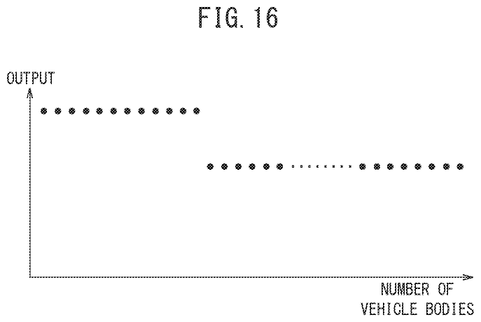

FIGS. 15 and 16 show examples of time-series data stored in the time-series data storage unit 50. There are cases where decrease in the output of the laser irradiated by the laser irradiation device 22 may be generated by a cause other than adhesion of spatters or fumes to the protective glass 31.

The time series data of FIG. 15 shows an example of a case where there is a defect in a roller (not shown) of the guide 26 of the brazing material supply device 20 of the laser irradiation device 22. The guide 26 feeds out the brazing material 14 by rotating the roller. When the output of the laser is to be measured, the guide 26 reversely rotates the roller by a predetermined length (predetermined rotation amount) and rewinds the brazing material 14 to a position where the brazing material 14 does not intercept the laser beam. However, due to wear of the roller, looseness of a position adjustment portion of the roller, or the like, there are cases where the brazing material 14 may not be sufficiently unwound and the brazing material 14 may intercept the laser beam. In this case, only when the brazing material 14 intercepts the laser beam at the time of measurement of the laser, a one-shot decrease in the laser output occurs accordingly. When there is a defect in the guide 26 as shown in the time-series data of FIG. 15, an event of the decrease in laser output occurs every several vehicle bodies, and the interval between the occurrences of the events gradually shortens.

As shown in the time-series data of FIG. 15, the laser irradiation state determination unit 44 determines that a defect has occurred in the roller of the guide 26 in a case where the event of the decrease in laser output occurs every several vehicle bodies and the interval between the occurrences of the events is gradually shortened. In this case, the notification control unit 46 controls the notification unit 48 to notify the operator that a defect has occurred in the roller of the guide 26.

The time-series data of FIG. 16 shows an example in which the irradiation head 30 of the laser irradiation device 22 interferes with an obstacle during machining and the position or posture of the irradiation head 30 is shifted. In a case where the position or the posture of the irradiation head 30 is deviated, as shown in the time-series data of FIG. 16, after the output of the laser decreases, the output is stabilized in the state where the output of the laser decreases. The laser irradiation state determination unit 44 determines that the irradiation head 30 has interfered with an obstacle during machining when the output of the laser is stabilized in the state in which the output of the laser decreases after the output of the laser decreases as in the time-series data of FIG. 16. In this case, the notification control unit 46 controls the notification unit 48 to notify the operator that the irradiation head 30 has interfered with an obstacle during machining.

In both the time series data (FIG. 16) obtained when the irradiation head 30 of the laser irradiation device 22 interferes with an obstacle during machining and the time series data (FIG. 13) obtained when spatters containing copper as the main component adhere to the protective glass 31 of the irradiation head 30 of the laser irradiation device 22, the output of the laser decreases stepwise. In a case where the output of the laser decreases stepwise, the laser irradiation state determination unit 44 may determine that the irradiation head 30 has interfered with an obstacle during machining or alternatively that spatters have adhered to the protective glass 31 of the irradiation head 30.

### [Operational Effects]

In the present embodiment, the laser output of the laser irradiation device 22 acquired by the output conversion unit 42 is stored as time-series data in the time-series data storage unit 50. Then, the laser irradiation state determination unit 44 determines the laser irradiation state of the laser irradiation device 22 based on the stored time-series data. As a result, it is possible to perform more detailed determination on the laser irradiation state.

### Invention Obtained from Embodiments

The inventions that are capable of being grasped from the above-described embodiments will be mentioned below.

There is provided a laser irradiation state determination method for determining an irradiation state of a laser beam emitted by a laser irradiation device (22), the method including: an output stabilization time acquisition step of acquiring, as an output stabilization time, a time from when the laser irradiation device starts irradiation of the laser beam to when an output of the laser beam is stabilized; an energy acquisition step of acquiring energy of the laser beam irradiated by the laser irradiation device for a predetermined time period set in advance, after the output stabilization time or more has elapsed since the laser irradiation device started the irradiation of the laser beam; a conversion step of converting the acquired energy into the output of the laser beam irradiated by the laser irradiation device; and a state determination step of determining the irradiation state of the laser beam based on the converted output of the laser beam. As a result, it is possible to obtain the output of the laser with high accuracy, and it is possible to improve the accuracy of determination by determining the irradiation state of the laser based on the highly accurately obtained output of the laser.

In the laser irradiation state determination method described above, the output stabilization time may be set in advance. As a result, since the process of obtaining the output stabilization time is not performed during machining, a load imposed on the laser irradiation state determination device 36 can be reduced.

In the above-described laser irradiation state determination method, the state determination step may determine the irradiation state of the laser beam by comparing the converted output of the laser beam with a preset threshold value. By determining the irradiation state of the laser by comparing the acquired output of the laser with the threshold value, it is possible to easily determine the irradiation state of the laser.

The laser irradiation state determination method may further include a time-series data storage step of storing the converted output of the laser beam as time series data, and the state determination step may determine the irradiation state of the laser beam on the basis of the time series data. As a result, it is possible to perform more detailed determination on the laser irradiation state.

### REFERENCE SIGNS LIST

22: laser irradiation device

What is claim is:

1.-4. (canceled)

5. A laser irradiation state determination method for determining an irradiation state of a laser beam emitted by a laser irradiation device, the method comprising:
an output stabilization time acquisition step of acquiring, as an output stabilization time, a time from when the laser irradiation device starts irradiation of the laser beam to when an output of the laser beam is stabilized;
an energy acquisition step of acquiring energy of the laser beam irradiated by the laser irradiation device for a predetermined time period set in advance, after the output stabilization time or more has elapsed since the laser irradiation device started the irradiation of the laser beam;
a conversion step of converting the acquired energy into the output of the laser beam irradiated by the laser irradiation device;
a time-series data storage step of storing the converted output of the laser beam as time-series data; and
a state determination step of determining the irradiation state of the laser beam based on the time-series data.

6. The laser irradiation state determination method according to claim 5, wherein
the output stabilization time is set in advance.
